(19) United States
(12) Patent Application Publication
(10) Pub. No.: US 2026/0310047 A1
(43) Pub. Date: Oct. 8, 2026

(54) CAMERA MODULE

(71) Applicant: SAMSUNG ELECTRO-MECHANICS CO., LTD., Suwon-si (KR)

(72) Inventors: Hong Joo LEE, Suwon-si (KR); Tae Won KANG, Suwon-si (KR)

(73) Assignee: SAMSUNG ELECTRO-MECHANICS CO., LTD., Suwon-si (KR)

(21) Appl. No.: 19/431,320

(22) Filed: Dec. 23, 2025

(30) Foreign Application Priority Data
Apr. 3, 2025 (KR) 10-2025-0043492

(51) Int. Cl. G03B 13/34; G02B 27/64; G03B 5/00

(52) U.S. Cl. CPC G03B 13/34; G02B 27/646; G03B 5/00; G03B 2205/0023; G03B 2205/0069

(57) ABSTRACT

A camera module includes a housing; a lens barrel accommodated in an internal space of the housing; a carrier accommodating the lens barrel and configured to be movable in an optical axis direction; a rolling member disposed between the carrier and the housing, and configured to roll along the optical axis direction; a focus adjustment driving portion including a focus adjustment magnet and a focus adjustment coil opposite each other with the rolling member interposed therebetween; and a tilt correction driving portion including a tilt correction magnet and a tilt correction coil and configured to generate a tilt driving force to offset tilting occurring in the carrier. The tilt correction driving portion generates the tilt driving force in the optical axis direction, and a direction of the tilt driving force is opposite to a direction of the focus driving force.

### CROSS-REFERENCE TO RELATED APPLICATIONS

This application claims the benefit under 35 USC 119(a) of Korean Patent Application No. 10-2025-0043492 filed on Apr. 3, 2025, in the Korean Intellectual Property Office, the entire disclosure of which is incorporated herein by reference for all purposes.

### BACKGROUND

### 1. Field

The present disclosure relates to a camera module.

### 2. Description of the Background

Camera modules have been used in portable electronic devices.

Due to the thinness of portable electronic devices, their camera modules often need to be designed in slimmer forms.

Camera modules may have a focus adjustment function, and the focus adjustment function may be implemented by moving a lens, or the like, in an optical axis direction.

However, in the process of moving the lens, or the like, in the optical axis direction, the lens, or the like, may tilt, which may cause misalignment of an optical axis. Such a phenomenon may be more likely to occur in slim camera modules with a long stroke.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes a housing having an internal space; a lens barrel accommodated in the internal space and in which at least one lens is disposed along an optical axis direction; a carrier accommodating the lens barrel and configured to be movable in the optical axis direction relative to the housing; a rolling member disposed between the carrier and the housing, the rolling member being configured to roll along the optical axis direction; a focus adjustment driving portion including a focus adjustment magnet and a focus adjustment coil opposite each other with the rolling member interposed therebetween, the focus adjustment driving portion being configured to generate focus driving force in the optical axis direction; and a tilt correction driving portion including a tilt correction magnet and a tilt correction coil and configured to generate a tilt driving force to offset tilting occurring in the carrier. The tilt correction driving portion generates the tilt driving force in the optical axis direction, and a direction of the tilt driving force is opposite to a direction of the focus driving force.

The focus adjustment driving portion may further include a first position sensor disposed on the housing to oppose the focus adjustment magnet. The focus adjustment magnet may be disposed on one side surface of the carrier, and the focus adjustment coil may be disposed on the housing to oppose the focus adjustment magnet with the rolling member interposed therebetween. The camera module may further include a first yoke disposed to oppose the focus adjustment magnet with the focus adjustment coil interposed therebetween, and configured to generate attractive force with the focus adjustment magnet.

The tilt correction driving portion may further include a tilt sensor disposed on the housing and configured to detect tilting of the carrier. The tilt correction magnet may be disposed on another side surface of the carrier, and the tilt correction coil may be disposed on the housing to oppose the tilt correction magnet.

One side surface of the carrier on which the focus adjustment magnet is disposed and another side surface of the carrier on which the tilt correction magnet is disposed may be either perpendicular or parallel to each other.

The tilt sensor may be disposed to oppose the other side surface of the carrier on which the tilt correction magnet is disposed. A shortest distance from the one side surface of the carrier on which the focus adjustment magnet is disposed to the tilt sensor may be greater than a shortest distance from the one side surface of the carrier on which the focus adjustment magnet is disposed to an optical axis.

The tilt sensor may be disposed on the housing to either oppose the tilt correction magnet or the focus adjustment magnet.

The camera module may include a first frame coupled to the lens barrel and supported on the carrier with a plurality of ball members interposed therebetween. The first frame may be movable in a first axis direction and a second axis direction, perpendicular to an optical axis, relative to the carrier. The camera module may further include an image stabilization driving portion including an image stabilization magnet and an image stabilization coil opposite each other and configured to generate driving force for moving the first frame in the first axis direction and the second axis direction.

The image stabilization magnet may include a first image stabilization magnet disposed on one side surface of the first frame, and a second image stabilization magnet disposed on another side surface of the first frame. The image stabilization coil may include a first image stabilization coil disposed on the housing to oppose the first image stabilization magnet, and a second image stabilization coil disposed on the housing to oppose the second image stabilization magnet.

The one side surface of the carrier on which the focus adjustment magnet is disposed and the other side surface of the carrier on which the tilt correction magnet is disposed may be perpendicular to each other. Each of the first image stabilization magnet and the second image stabilization magnet may be disposed to be parallel to one of the focus adjustment magnet and the tilt correction magnet.

The one side surface of the carrier on which the focus adjustment magnet is disposed and the other side surface of the carrier on which the tilt correction magnet is disposed may be parallel to each other. The first image stabilization magnet and the second image stabilization magnet may be disposed to be parallel to each other.

The focus adjustment coil, the tilt correction coil, the first image stabilization coil, and the second image stabilization coil may be disposed on different side surfaces of the housing, respectively.

The camera module may further include a main board on which the focus adjustment coil, the tilt correction coil, the first image stabilization coil, and the second image stabilization coil are disposed. The main board may be disposed across the entire side surfaces of the housing.

In another general aspect, a camera module includes a housing; a carrier accommodating a lens barrel in which at least one lens is disposed along an optical axis direction and supported by the housing; a focus adjustment driving portion including a focus adjustment magnet and a focus adjustment coil disposed on one side of the carrier; a tilt correction driving portion including a tilt correction magnet and a tilt correction coil disposed on another side of the carrier; a first rolling member, disposed on the one side of the carrier, including a first set of ball members; and a second rolling member, disposed on the one side of the carrier to be spaced apart from the first rolling member, including a second set of ball members fewer than the first set of ball members. A shortest distance between the tilt correction driving portion and the first rolling member is equal to or greater than a shortest distance between the tilt correction driving portion and the second rolling member.

The one side of the carrier on which the focus adjustment driving portion is disposed and the other side of the carrier on which the tilt correction driving portion is disposed may be either perpendicular or parallel to each other.

A first position sensor configured to detect positions in the optical axis direction of the lens barrel and the carrier may be disposed on the one side of the carrier. A tilt sensor configured to detect tilting of the lens barrel and the carrier may be disposed either on the one side of the carrier or the other side of the carrier.

Other features and aspects will be apparent from the following detailed description, the drawings, and the claims.

### BRIEF DESCRIPTION OF DRAWINGS

FIG. 1 is a perspective view of a camera module according to example embodiments of the present disclosure.

FIG. 2 is an exploded perspective view of a camera module according to an example embodiment of the present disclosure.

FIG. 3 is an exploded perspective view of components related to a focus adjustment portion according to an example embodiment of the present disclosure.

FIG. 4A is an exploded perspective view of components related to an image stabilization portion according to an example embodiment of the present disclosure.

FIG. 4B is an exploded perspective view of components related to an image stabilization portion according to another example embodiment of the present disclosure.

FIG. 5 illustrates a tilt correction driving portion according to an example embodiment of the present disclosure.

FIG. 6 is a diagram illustrating tilt occurrence and a tilt correction method according to an example embodiment of the present disclosure.

FIGS. 7 and 8 illustrate modifications of a tilt correction driving portion according to an example embodiment of the present disclosure.

FIG. 9 is a diagram illustrating a tilt correction driving portion according to another example embodiment of the present disclosure.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being "on," "connected to," or "coupled to" another element, it may be directly "on," "connected to," or "coupled to" the other element, or there may be one or more other elements intervening therebetween. In contrast, when an element is described as being "directly on," "directly connected to," or "directly coupled to" another element, there can be no other elements intervening therebetween.

As used herein, the term "and/or" includes any one and any combination of any two or more of the associated listed items; likewise, "at least one of" includes any one and any combination of any two or more of the associated listed items.

Although terms such as "first," "second," and "third" may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as "above," "upper," "below," "lower," and the like, may be used herein for ease of description to describe one element’s relationship to another element as shown in the figures. Such spatially relative terms are intended to encompass different orientations of the device in use or operation in addition to the orientation depicted in the figures. For example, if the device in the figures is turned over, an element described as being "above," or "upper" relative to another element would then be "below," or "lower" relative to the other element. Thus, the term "above" encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles "a," "an," and "the" are intended to include the plural forms as well, unless the context clearly indicates otherwise. The terms "comprises," "includes," and "has" specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term "may" with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

The present disclosure relates to a camera module 1000. The camera module 1000 according to the present disclosure may be applied to a portable electronic device such as a mobile communication terminal, a smartphone, a tablet PC, or the like.

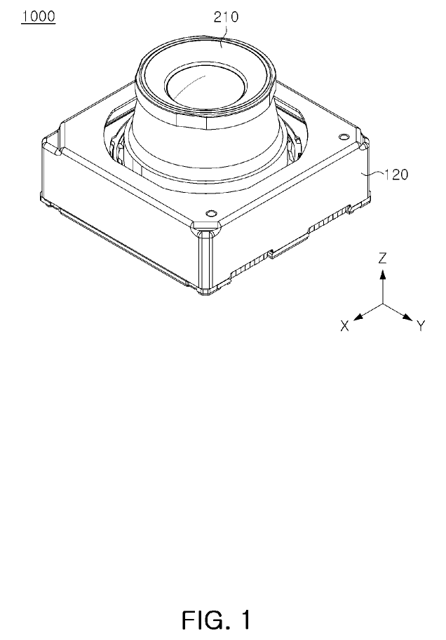

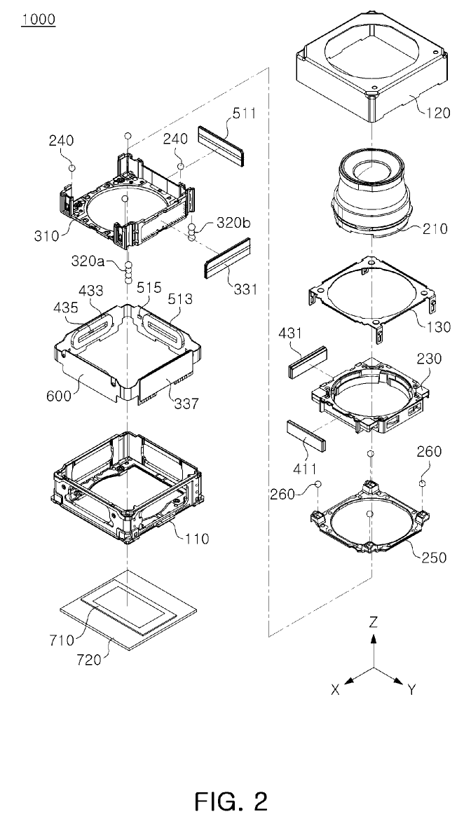

FIG. 1 is a perspective view of a camera module according to an example embodiment of the present disclosure. FIG. 2 is an exploded perspective view of a camera module according to an example embodiment of the present disclosure.

Referring to FIGS. 1 and 2, a camera module 1000 may include a lens barrel 210, a lens driving portion moving the lens barrel 210, and an image sensor 710 converting light incident on the lens barrel 210 into an electrical signal.

The lens barrel 210 may have a hollow cylindrical shape, and a plurality of lenses may be disposed in the lens barrel 210 along an optical axis (Z-axis).

The lens driving portion may be a portion moving the lens barrel 210, and may include a focus adjustment portion moving the lens barrel 210 in an optical axis direction (Z-axis direction), and an image stabilization portion moving the lens barrel 210 in directions (X-axis and Y-axis directions), perpendicular to the optical axis (Z-axis).

The image sensor 710 may be an apparatus for converting light incident on the lens barrel 210 into an electrical signal, and may be mounted on a printed circuit board 720.

Light incident on the lens barrel 210 may be converted into an electrical signal by the image sensor 710 and be output in the form of an image or video through a display unit of a portable electronic device.

The camera module 1000 may include a housing 110 in which the above-described components are disposed. For example, the housing 110 may have a rectangular box shape having an internal space.

In addition, the camera module 1000 may include a shield can 120 bonded to the housing 110 to seal the internal space.

The shield can 120 may protect the components disposed in the housing 110, and may be formed of a metal material to shield electromagnetic waves.

The main board 600 may be attached to an external surface of the housing 110. For example, a portion of the main board 600 may be bent, such that the main board 600 may be disposed across four side surfaces of the housing 110. Alternatively, the main board 600 may be disposed on each of the four side surfaces of the housing 110.

A portion of a driving portion to be described below may be mounted on the main board 600.

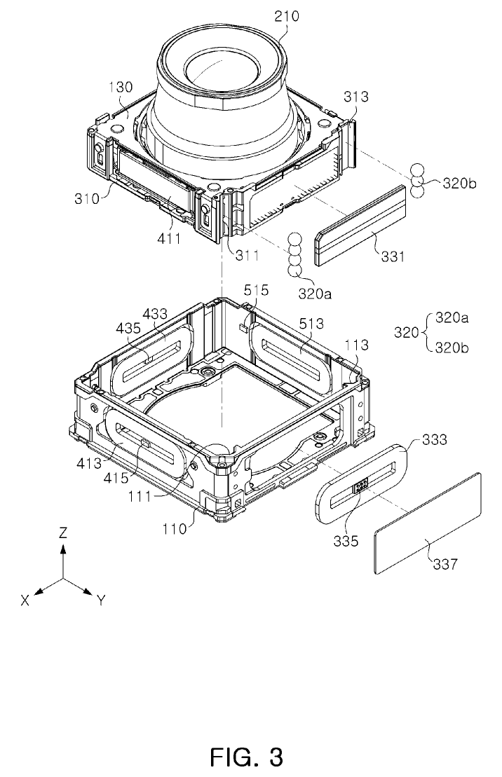

FIG. 3 is an exploded perspective view of components related to a focus adjustment portion according to an example embodiment of the present disclosure.

Referring to FIG. 3, the focus adjustment portion may include a carrier 310 accommodating the lens barrel 210, and a focus adjustment driving portion generating driving force for moving the lens barrel 210 and the carrier 310 in the optical axis direction (Z-axis direction).

The carrier 310 may accommodate the lens barrel 210, and may be accommodated in the internal space of the housing 110.

The carrier 310 may move in the optical axis direction (Z-axis direction) due to driving force formed by the focus adjustment driving portion. In this case, the lens barrel 210 accommodated in the carrier 310 may also move in the optical axis direction (Z-axis direction).

The focus adjustment driving portion may include a focus adjustment magnet 331 disposed on the carrier 310, and a focus adjustment coil 333 disposed on the housing 110.

The focus adjustment magnet 331 may be disposed on one side surface of the carrier 310, and the focus adjustment coil 333 may be disposed on the housing 110 to oppose the focus adjustment magnet 331. The focus adjustment coil 333 may be disposed on the housing 110 via the main board 600. The housing 110 may have a through-hole, and the focus adjustment magnet 331 and the focus adjustment coil 333 may directly oppose each other through the through-hole.

An N pole, a neutral region, and an S pole may be provided on one surface of the focus adjustment magnet 331, opposing the focus adjustment coil 333, in the optical axis direction (Z-axis direction).

When power is applied to the focus adjustment coil 333, the focus adjustment magnet 331 and the focus adjustment coil 333 may generate driving force in the optical axis direction (Z-axis direction).

The rolling member 320 may be disposed between the carrier 310 and the housing 110. The rolling member 320 may reduce friction between the carrier 310 and the housing 110 while rolling in the optical axis direction (Z-axis direction) when the carrier 310 moves.

The rolling member 320 may be a plurality of ball members arranged in the optical axis direction (Z-axis direction), and may be disposed on both sides of the focus adjustment magnet 331.

A rolling member 320a, disposed on one side of the focus adjustment magnet 331, may be a main guide, and a rolling member 320b, disposed on the other side of the focus adjustment magnet 331, may be an auxiliary guide.

In the present specification, the first rolling member 320a and the second rolling member 320b disposed on one side of the focus adjustment magnet 331 are described as the main guide and the auxiliary guide, respectively. However, in other example embodiments, both the first rolling member 320a and the second rolling member 320b may be the main guide. In this case, the number of ball members and a shape of a guide groove described below may be equally applied to the first rolling member 320a and the second rolling member 320b.

The first rolling member 320a and the second rolling member 320b may include different numbers of ball members. For example, the first rolling member 320a, the main guide, may include more ball members than the second rolling member 320b, the auxiliary guide.

The rolling member 320 may be fitted into a space between guide grooves, opposing each other.

The carrier 310 may include a first guide groove 311 and a second guide groove 313, and the housing 110 may include a third guide groove 111 opposing the first guide groove 311, and a fourth guide groove 113 opposing the second guide groove 313. The first guide groove 311 and the third guide groove 111, and the second guide groove 313 and the fourth guide groove 113 may oppose each other in one direction, perpendicular to the optical axis (Z-axis).

The first rolling member 320a may be fitted into a space between the first guide groove 311 and the third guide groove 111, and the second rolling member 320b may be fitted into a space between the second guide groove 313 and the fourth guide groove 113.

The first to fourth guide grooves 311, 313, 111, and 113 may extend in the optical axis direction (Z-axis direction), such that the rolling member 320 may roll along the optical axis direction (Z-axis direction).

Cross-sections of the first to fourth guide grooves 311, 313, 111, and 113, cut to be perpendicular to the optical axis (Z-axis), may have a “V” shape or a “─” shape.

The first guide groove 311 and the third guide groove 111, into which the first rolling member 320a is fitted, may have a “V”-shaped cross-section when cut to be perpendicular to the optical axis (Z-axis), and the first rolling member 320a may be in two-point contact with each of the first guide groove 311 and the third guide groove 111.

The second guide groove 313 and the fourth guide groove 113, into which the second rolling member 320b is fitted, may have a “V” shaped cross-section or a “─” shaped cross-section when cut to be perpendicular to the optical axis (Z-axis), and the second rolling member 320b may be in one-point and two-point contact (or two-point and one-point contact) with each of the second guide groove 313 and the fourth guide groove 113.

The fourth rolling member 260 may be in two-point contact with each of a seventh guide groove 237 and an eighth guide groove 257.

A first yoke 337 may be disposed on the housing 110. The first yoke 337 may be disposed on an external surface of the main board 600, for example, a surface opposite a surface on which the focus adjustment coil 333 is disposed.

The first yoke 337 may have a length greater than that of the focus adjustment magnet 331 in the optical axis direction (Z-axis direction).

The first yoke 337 may be a magnetic body disposed to oppose the focus adjustment magnet 331. The first yoke 337 and the focus adjustment magnet 331 may oppose each other in one direction, perpendicular to the optical axis (the Z-axis). Magnetic attractive force may act between the first yoke 337 and the focus adjustment magnet 331 in directions in which the first yoke 337 and the focus adjustment magnet 331 oppose each other.

The carrier 310 may be closely supported by the housing 110 in a direction in which magnetic attractive force is applied, and the rolling member 320 may be maintained in a state of being in contact with the carrier 310 and the housing 120.

A stopper 130 may be bonded to the carrier 310. The stopper 130 may cover an open upper portion of the carrier 310 accommodating the lens barrel 210 or the like, and may prevent separation of components accommodated in the carrier 310. In addition, the stopper 130 may have a damper. The damper may be formed of an elastic material, may limit a movement range of the carrier 310, and may reduce collision and noise caused by driving of the carrier 310.

A closed-loop control method for sensing and feeding back a position of the lens barrel 210 may be used for the camera module 100.

The focus adjustment driving portion may include a first position sensor 335 detecting a position in the optical axis direction (Z-axis direction) of the lens barrel 210.

The first position sensor 335 may be disposed on the main board 600, together with the focus adjustment coil 333. The first position sensor 335 may be disposed on the inside of the focus adjustment coil 333.

The first position sensor 335 may directly oppose the focus adjustment magnet 331 through the through-hole.

The first position sensor 335 may detect a position of the lens barrel 210 by sensing a change in a magnetic field. For example, the first position sensor 335 may be provided as a Hall sensor or another type of magnetic sensor.

Unintended tilting may occur in the carrier 310 during focus adjustment.

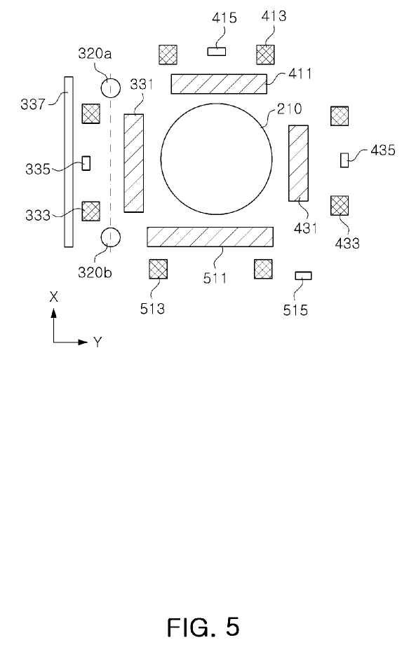

According to example embodiments of the present disclosure, the camera module 1000 may include a tilt correction driving portion that senses and corrects the tilting of the carrier 310. Example embodiments of the tilt correction driving portion are illustrated in FIGS. 5-9, and will be described below.

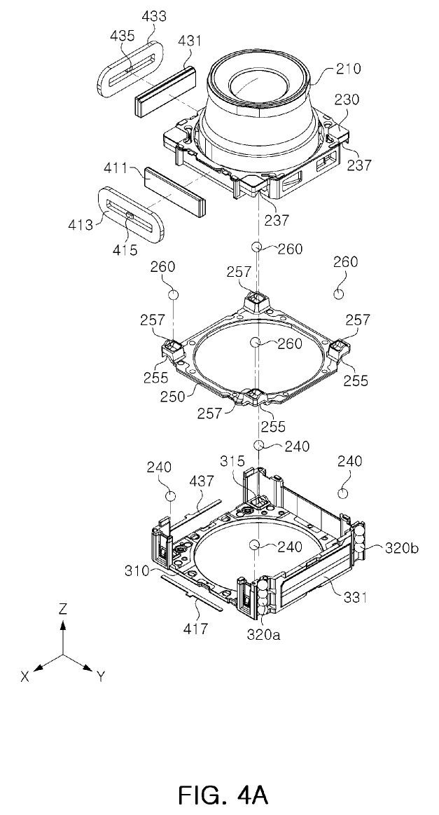

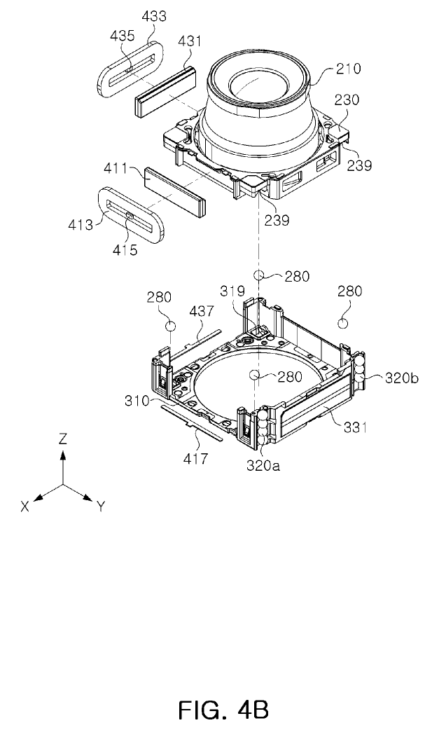

FIG. 4A is an exploded perspective view of components related to an image stabilization portion according to an example embodiment of the present disclosure.

The image stabilization portion may compensate for shaking by imparting a relative displacement to lens barrel 210 in response to shaking caused by factors such as hand tremor of a user during video recording or the like.

Referring to FIG. 4, the image stabilization portion may include an image stabilization driving portion generating driving force for moving a first frame 230, a second frame 250, and the lens barrel 210 in directions (X-axis and Y-axis directions), perpendicular to the optical axis (Z-axis).

The lens barrel 210 may move in directions (X-axis and Y-axis directions), perpendicular to the optical axis (Z-axis), together with the first frame 230 and the second frame 250.

The lens barrel 210 may be bonded to the first frame 230, and the first frame 230 may be supported by the second frame 250. The first frame 230 and the second frame 250 may be accommodated in the carrier 310.

The first frame 230 and the second frame 250 may be in directions (X-axis and Y-axis directions), perpendicular to the optical axis (Z-axis), due to the driving force formed by the image stabilization driving portion.

In an example embodiment, the second frame 250 may move in a first axis direction (X-axis direction), perpendicular to the optical axis (Z-axis), and the first frame 230 may move in the first axis direction (X-axis direction) and in a second axis direction (Y-axis direction), perpendicular to both the optical axis (Z-axis) and the first axis (X-axis).

The image stabilization driving portion may include image stabilization magnets 411 and 431 disposed on the first frame 230, and image stabilization coils 413 and 433 disposed on the housing 110.

The image stabilization magnets 411 and 431 may be disposed on two side surfaces, perpendicular to each other, of the first frame 230, and the image stabilization coils 413 and 433 may be disposed on the housing 110 to oppose the image stabilization magnets 411 and 431. The image stabilization coil 433 may be disposed on the housing 110 via the main board 600.

The carrier 310 may be open in positions corresponding to positions of the two side surfaces of the first frame 230 on which the image stabilization magnets 411 and 431 are disposed, and the housing 110 may have through-holes, such that the image stabilization magnets 411 and 431 and the image stabilization coils 413 and 433 may directly oppose each other through the through-holes.

When power is applied to the image stabilization coils 413 and 433, the image stabilization magnets 411 and 431 and the image stabilization coils 413 and 433 may generate driving force in directions in which the image stabilization magnets 411 and 431 and the image stabilization coils 413 and 433 oppose each other.

In an example embodiment, a first image stabilization magnet 411 and a first image stabilization coil 413 may oppose each other in a first axis direction (X-axis direction), and may generate driving force in the first axis direction (a first image stabilization driving portion). In addition, a second image stabilization magnet 431 and a second image stabilization coil 433 may oppose each other in a second axis direction (Y-axis direction), and may generate driving force in the second axis direction (a second image stabilization driving portion).

In another example embodiment, the first image stabilization magnet 411 and the first image stabilization coil 413 may oppose each other in the first axis direction (X-axis direction), and may generate driving force in the second axis direction (Y-axis direction), and the second image stabilization magnet 431 and the second image stabilization coil 433 may oppose each other in the second axis direction (Y-axis direction), and may generate driving force in the first axis direction (X-axis direction).

Rolling members 240 and 260 may be disposed between the second frame 250 and the carrier 310 and between the first frame 230 and the second frame 250, respectively.

In an example embodiment, a third rolling member 240 may be disposed between the second frame 250 and the carrier 310, and a fourth rolling member 260 may be disposed between the first frame 230 and the second frame 250.

The third rolling member 240 may include three or more ball members. For example, the third rolling member 240 may include four ball members, and the four ball members may be disposed at the corners of the third rolling member 240, respectively.

Corners of the second frame 250 and the carrier 310 may include guide grooves, respectively.

The second frame 250 may include a fifth guide groove 255, and the carrier 310 may include a sixth guide groove 315 opposing the fifth guide groove 255. The fifth guide groove 255 and the sixth guide groove 315 may oppose each other in the optical axis direction (Z-axis direction).

The third rolling member 240 may be fitted into a space between the fifth guide groove 255 and the sixth guide groove 315.

The fifth guide groove 255 and the sixth guide groove 315 may extend in the first axis direction (X-axis direction), and cross-sections of the fifth guide groove 255 and the sixth guide groove 315, cut to be parallel to the optical axis (Z-axis), may have a “V”-shape.

The third rolling member 240 may be in two-point contact with each of the fifth guide groove 255 and the sixth guide groove 315.

When driving force is generated in the first axis direction (X-axis direction), the third rolling member 240 may have limited movement in the second axis direction (Y-axis direction) while rolling along the fifth guide groove 255 and the sixth guide groove 315 in the first axis direction (X-axis direction).

The fourth rolling member 260 may include three or more ball members. For example, the fourth rolling member 260 may include four ball members, and the four ball members may be disposed at the corners of the fourth rolling member 260, respectively.

Corners of the first frame 230 and the second frame 250 may include guide grooves, respectively.

The first frame 230 may include a seventh guide groove 237, and the second frame 250 may include an eighth guide groove 257. The seventh guide groove 237 and the eighth guide groove 257 may oppose each other in the optical axis direction (Z-axis direction).

The fourth rolling member 260 may be fitted into a space between the seventh guide groove 237 and the eighth guide groove 257.

The seventh guide groove 237 and the eighth guide groove 257 may extend in the second axis direction (Y-axis direction), and may have a “V”-shaped cross-section when cut to be parallel to the optical axis (Z-axis).

The fourth rolling member 260 may be in two-point contact with each of the seventh guide groove 237 and the eighth guide groove 257.

When driving force is generated in the second axis direction (Y-axis direction), the fourth rolling member 260 may roll along the second axis direction (Y-axis direction) along the seventh guide groove 237 and the eighth guide groove 257, and movement in the first axis direction (X-axis direction) may be limited.

FIG. 4B is an exploded perspective view of components related to an image stabilization portion according to another example embodiment of the present disclosure.

According to another example embodiment of the present disclosure, the image stabilization portion may have a structure in which the second frame 250 is omitted. In another example embodiment, the lens barrel 210 may be bonded to the first frame 230, and the first frame 230 may be accommodated in the carrier 310.

The first frame 230 may move in the first axis direction (X-axis direction) and the second axis direction (Y-axis direction) due to driving force formed by the image stabilization portion together with the lens barrel 210.

A rolling member (hereinafter referred to as a fifth rolling member) 280 may be disposed between the first frame 230 and the carrier 310.

The fifth rolling member 280 may include three or more ball members. For example, the fifth rolling member 280 may include four ball members, and the four ball members may be disposed at the corners of the fifth rolling member 280, respectively.

Corners of the first frame 230 and the carrier 310 may include guide grooves, respectively.

The first frame 230 may include a ninth guide groove 239, and the carrier 310 may include a tenth guide groove 319 opposing the ninth guide groove 239. The ninth guide groove 239 and the tenth guide groove 319 may oppose each other in the optical axis direction (Z-axis direction).

The fifth rolling member 280 may be fitted into a space between the ninth guide groove 239 and the tenth guide groove 319.

The ninth guide groove 239 and the tenth guide groove 319 may have a ‘─’ shaped cross-section when cut to be parallel to the optical axis (Z-axis), and the fifth rolling member 280 may be in one-point contact with each of the ninth guide groove 239 and the tenth guide groove 319.

In addition, the ninth guide groove 239 and the tenth guide groove 319 may have a shape that does not limit the movement direction of the fifth rolling member 280. For example, the ninth guide groove 239 and the tenth guide groove 319 may have a length in the first axis direction (X-axis direction) and the second axis direction (Y-axis direction), greater than a diameter of the fifth rolling member 280.

The fifth rolling member 280 may freely roll on a plane (X-Y plane), perpendicular to the optical axis (Z-axis), in a state of being fitted into a space between the ninth guide groove 239 and the tenth guide groove 319.

In the example embodiment illustrated in FIG. 4B, one of the second frame 250, the third rolling member 240, and the fourth rolling member 260 may be omitted, and slimming of the camera module 1000 may be achieved. As illustrated in FIG. 4B, in a structure in which the camera module 100 is slim in the optical axis direction (Z-axis direction), tilting of the carrier 310 may occur more frequently.

In the example embodiments of FIGS. 4A and 4B, second yokes 417 and 437 may be disposed on the carrier 310. The second yokes 417 and 437 may be disposed on a bottom surface of the carrier 310 toward the first frame 230.

The second yokes 417 and 437 may be disposed to oppose image stabilization magnets 411 and 431. The second yokes 417 and 437 and the image stabilization magnets 411 and 431 may oppose each other in an optical axis direction (Z-axis direction). Magnetic attractive force may act between the second yokes 417 and 437 and the image stabilization magnets 411 and 431 in directions in which the second yokes 417 and 437 and the image stabilization magnets 411 and 431 oppose each other.

The first frame 230 (and the second frame 250) may be closely supported by the carrier 310 in a direction in which magnetic attractive force acts, and the rolling members 240, 260, and 280 may be maintained in a state of being in contact with the first frame 230, the second frame 250, and the carrier 310.

The image stabilization portion may include a second position sensor 415 detecting a position of the lens barrel 210 in the first axis direction (X-axis direction), and a third position sensor 435 detecting a position of the lens barrel 210 in the second axis direction (Y-axis direction).

The second position sensor 415 and the third position sensor 435 may be disposed on the main board 600 together with the image stabilization coils 413 and 433. The second position sensor 415 and the third position sensor 435 may be disposed on the inside of the image stabilization coils 413 and 433.

The second position sensor 415 and the third position sensor 435 may directly oppose the image stabilization magnets 411 and 431 through through-holes.

The second position sensor 415 and the third position sensor 435 may detect a position of the lens barrel 210 by sensing a change in a magnetic field. For example, the second position sensor 415 and the third position sensor 435 may be provided as Hall sensors or other types of magnetic sensors.

Hereinafter, a tilt correction driving portion of the camera module 1000 according to example embodiments of the present disclosure will be described.

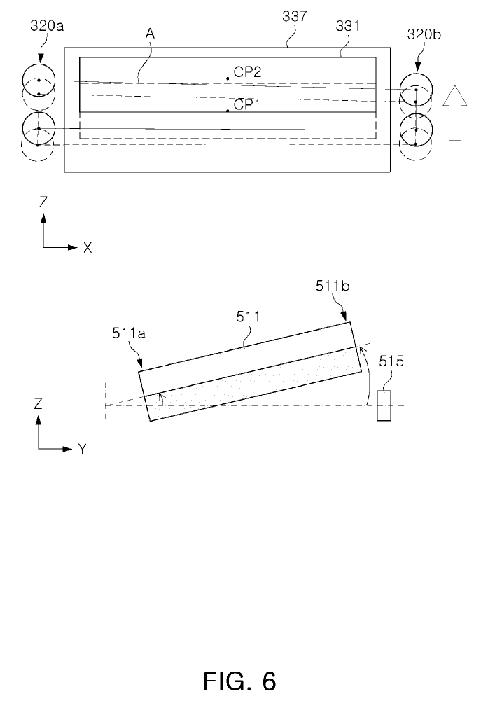

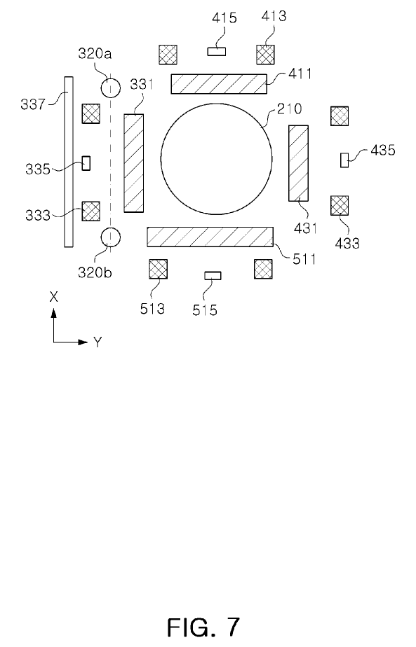

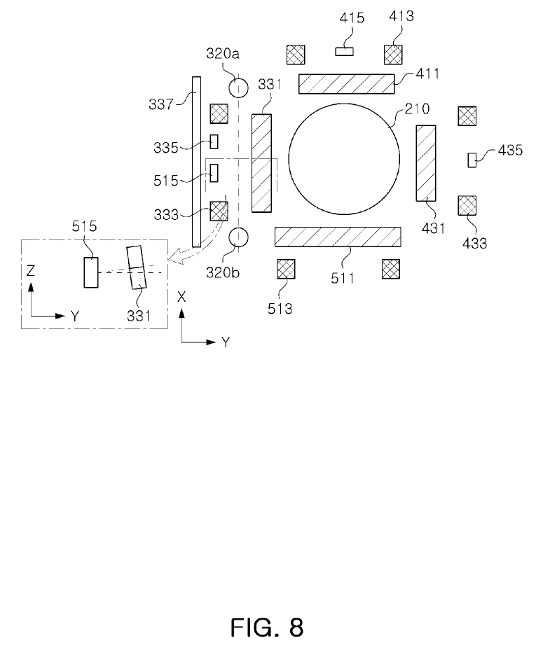

FIG. 5 illustrates a tilt correction driving portion according to an example embodiment of the present disclosure. FIG. 6 is a diagram illustrating tilt occurrence and a tilt correction method according to an example embodiment of the present disclosure. FIGS. 7 and 8 illustrate modifications of a tilt correction driving portion according to an example embodiment of the present disclosure.

The tilt correction driving portion may include a tilt correction magnet 511 disposed on the carrier 310, and a tilt correction coil 513 disposed on the housing 110.

The tilt correction magnet 511 may be disposed on one side surface of the carrier 310, and the tilt correction coil 513 may be disposed on the housing 110 to oppose the tilt correction magnet 511. The tilt correction coil 513 may be disposed on the housing 110 via the main board 600. The housing 110 may have a through-hole, and the tilt correction magnet 511 and the tilt correction coil 513 may directly oppose each other through the through-hole.

In example embodiments of the present disclosure, the focus adjustment magnet 331 and the tilt correction magnet 511 may be disposed on the carrier 310.

According to an example embodiment of the present disclosure, one side surface of the carrier 310 on which the focus adjustment magnet 331 is disposed and one side surface of the carrier 310 on which the tilt correction magnet 511 is disposed may be perpendicular to each other.

Referring to FIG. 5, the focus adjustment magnet 331 and the tilt correction magnet 511 may be disposed on two side surfaces of the carrier 310, perpendicular to each other, and the first and second image stabilization magnets 411 and 431 may be disposed on two side surfaces of the first frame 230, perpendicular to each other. The second image stabilization magnet 431 (or the first image stabilization magnet 411) may be disposed to oppose the focus adjustment magnet 331, and the first image stabilization magnet 411 (or the second image stabilization magnet 431) may be disposed to oppose the tilt correction magnet 511. One side surface of the carrier 310 on which the tilt correction magnet 511 is disposed may extend from a side of the second rolling member 320b, and the one side surface of the carrier 310 on which the tilt correction magnet 511 is disposed may be spaced apart from the first rolling member 320a. In addition, the focus adjustment coil 313, the tilt correction coil 513, the first image stabilization coil 413, and the second image stabilization coil 433 may be disposed on four side surfaces of the housing 110.

In the example embodiment illustrated in FIG. 5, the first and second image stabilization magnets 411 and 431 and the first and second image stabilization coils 413 and 433 may all generate driving force in directions in which the first and second image stabilization magnets 411 and 431 and the first and second image stabilization coils 413 and 433 oppose each other or in directions, perpendicular to the directions in which the first and second image stabilization magnets 411 and 431 and the first and second image stabilization coils 413 and 433 oppose each other.

The tilt correction driving portion may include a tilt sensor 515 sensing tilting of the lens barrel 210.

The tilt sensor 515 may be disposed on the main board 600 together with the tilt correction coil 513. The tilt sensor 515 may be disposed on the outside or the inside of the tilt correction coil 513.

The tilt sensor 515 may sense tilting of the lens barrel 210 by sensing a change in a magnetic field. The tilt sensor 515 may be a magnetic sensor, such as an anisotropic magneto-resistive (AMR) sensor, a tunnel magneto-resistance sensor (TMR) sensor, or a sensor sensing rotation or angle. Alternatively, the tilt sensor 515 may be a Hall sensor linearly outputting a change in a magnetic field. The tilt sensor 515 may sense tilting of the carrier 310 alone or in association with a sensing value of the first position sensor 335.

A type of the tilt sensor 515 and a method of sensing the tilt sensor 515 may be equally applied to all example embodiments, and may be appropriately selected and applied in each of the example embodiments.

Tilt correction of the camera module 100 may be performed using a closed-loop control method in which tilting (tilt amount) of the carrier 310 is sensed and fed back.

When tilting of the carrier 310 is sensed by the tilt sensor 515, power may be applied to the tilt correction coil 513, and the tilt correction magnet 511 and the tilt correction coil 513 may generate driving force in the optical axis direction (Z-axis direction).

Accordingly, in the same manner as the focus adjustment magnet 331, one surface of the tilt correction magnet 511, opposing the tilt correction coil 513, may include an N pole, a neutral region, and an S pole in the optical axis direction (Z-axis direction).

The tilt correction magnet 511 and the tilt correction coil 513 may generate driving force to offset the tilt amount of the carrier 310.

The tilt correction magnet 511 and the tilt correction coil 513 may generate driving force in the optical axis direction (Z-axis direction). A position in which the driving force is generated by the tilt correction magnet 511 and the tilt correction coil 513 may be spaced apart from a tilting axis of the carrier 310, for example, one side surface of the carrier 310 supported by the housing 110 (a surface parallel to the optical axis (Z-axis)), or the first rolling member 320a, such that the carrier 310 may be tilted by the driving force generated in the optical axis direction (Z-axis direction).

During focus adjustment, a difference may be present between a distance by which the carrier 310 moves in the optical axis direction (Z-axis direction) and a distance by which the rolling member 320 moves in the optical axis direction (Z-axis direction), and the difference may cause tilting of the carrier 310.

Referring to FIG. 6, when the carrier 310 moves in the optical axis direction (Z-axis direction), the focus adjustment magnet 331 disposed on the carrier 310 may move in the optical axis direction (Z-axis direction) by the same distance as the carrier 310, and a center of attractive force acting between the focus adjustment magnet 331 and the first yoke 337 may also move in the optical axis direction (Z-axis direction) (CP1 → CP2).

The rolling member 320 may support movement of the carrier 310 in the optical axis direction (Z-axis direction) while rolling in the optical axis direction (Z-axis direction). However, an amount of movement of the rolling member 320 in the optical axis direction (Z-axis direction) may be less than an amount of movement of the carrier 310 in the optical axis direction (Z-axis direction).

In order for the carrier 310 to stably move in the optical axis direction (Z-axis direction), a center of attractive force acting on the carrier 310 may need to be positioned in a support region A defined by the rolling member 320. When the center of attractive force is positioned in a central portion of the support region A, it may be advantageous for the carrier 310 to stably move.

However, as described above, an amount of movement of the rolling member 320 may be less than an amount of movement of the carrier 310, the center of attractive force may deviate from the central portion of the support region A or from the support region A according to the movement of the carrier 310, and accordingly, the carrier 310 may be tilted.

As illustrated in FIG. 6, when the carrier 310 moves upwardly in the optical axis direction and a center CP2 of attractive force is positioned on the outside of the support region A, for example, on an upper side of the support region A, the carrier 310 may tilt, such that a distance between an upper side of the carrier 310 and one side surface of the housing 110 on which the first yoke 337 is disposed may decrease.

The tilt sensor 515 may sense tilting of the carrier 310.

In an example embodiment, the tilt sensor 515 may be disposed on one side surface of the housing 110 opposing the tilt correction magnet 511, and may be positioned farther from another side surface of the housing 110 supporting the carrier 310. For example, the tilt sensor 515 may be disposed on one side surface of the housing 110 opposing the tilt correction magnet 511. In this case, the tilt sensor 515 may be positioned closer to another side surface of the housing 110 on which the second image stabilization coil 433 is disposed, than to yet another side surface of the housing 110 supporting the carrier 310 opposing the other side surface of the housing.

When the tilt sensor 515 is disposed in the position described above, the tilt correction driving portion may effectively correct tilting of the carrier 310.

The carrier 310 may tilt around the rolling member 320, an amount of rotation may increase in a position farther from a position of the rolling member 320.

For example, on one side surface of the carrier 310 on which the tilt correction magnet 511 is disposed, an amount of rotation of one end 511a in a length direction of the tilt correction magnet 511, adjacent to the rolling member 320, may be less than an amount of rotation of the other end 511b in the length direction of the tilt correction magnet 511.

Accordingly, a greater magnetic field change may occur in the other end 511b in the length direction of the tilt correction magnet 511, and the tilt sensor 515 may more sensitively sense rotation of the carrier 310.

At the same time, a distance between the tilt correction driving portion and the tilting axis may be secured, such that tilting of the carrier 310 may be efficiently corrected with a smaller driving force.

In an example embodiment, the tilt sensor 515 may be disposed on the outside of the tilt correction coil 513, may oppose one side surface of the carrier 310 on which the tilt correction magnet 511 is disposed, and may not oppose the tilt correction magnet 511. Alternatively, similarly, the tilt sensor 515 may be disposed on the outside of the tilt correction coil 513, and may oppose the other end 511b in the length direction of the tilt correction magnet 511. In the latter case, a length of the tilt correction coil 513 may be less than a length of the tilt correction magnet 511.

Referring to FIG. 7, in a modification, the tilt sensor 515 may be disposed on the inside of the tilt correction coil 513, and may oppose a central portion in the length direction of the tilt correction magnet 511.

Referring to FIG. 8, in a modification, the tilt sensor 515 may be disposed to oppose the focus adjustment magnet 331.

The tilt sensor 515 may be disposed on a surface of the substrate 600 where the focus adjustment coil 333 and the first position sensor 335 are disposed. The first position sensor 335 and the tilt sensor 515 may be disposed on the inside of the focus adjustment coil 333 to be parallel to each other.

In a modification, the tilt sensor 515 may detect tilting of the carrier 310 based on a change in a magnetic field of the focus adjustment magnet 331.

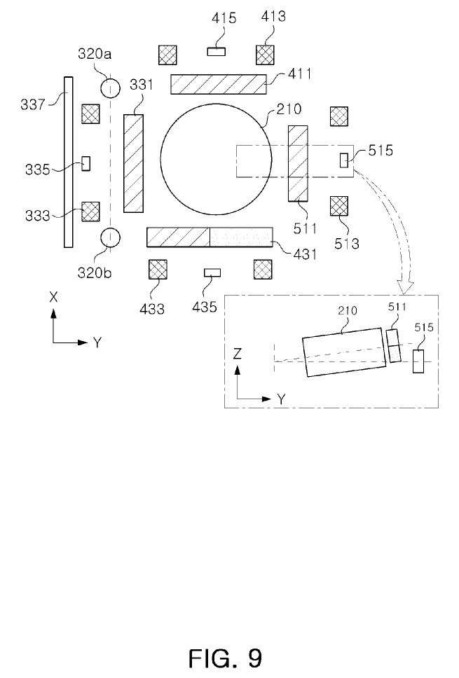

FIG. 9 is a diagram illustrating a tilt correction driving portion according to another example embodiment of the present disclosure.

According to another example embodiment of the present disclosure, one side surface of the carrier 310 on which the focus adjustment magnet 331 is disposed and one side surface of the carrier 310 on which the tilt correction magnet 511 is disposed may be parallel to each other.

Referring to FIG. 9, the focus adjustment magnet 331 and the tilt correction magnet 511 may be disposed on two side surfaces of the carrier 310 parallel to each other, that is, two side surfaces of the carrier 310 opposing each other, and the first and second image stabilization magnets 411 and 431 may be disposed on two side surfaces of the first frame 230 parallel to each other, that is, two side surfaces of the first frame 230 opposing each other. The tilt correction magnet 511 may be disposed to oppose the focus adjustment magnet 331, and the first and second image stabilization magnets 411 and 431 may be disposed to oppose each other. In addition, the focus adjustment coil 333, the tilt correction coil 513, the first image stabilization coil 413, and the second image stabilization coil 433 may be disposed on four side surfaces of the housing 110.

In the example embodiment illustrated in FIG. 9, the first image stabilization magnet 411 and the first image stabilization coil 413 may generate driving force in directions in which the first image stabilization magnet 411 and the first image stabilization coil 413 oppose each other, and the second image stabilization magnet 431 and the second image stabilization coil 433 may generate driving force in directions, perpendicular to the directions in which the first image stabilization magnet 411 and the first image stabilization coil 413 oppose each other, or vice versa.

In another example embodiment of the present disclosure, the tilt correction driving portion may be disposed on an opposite side of the focus adjustment driving portion relative to the optical axis (Z-axis) (or the lens barrel 210). The tilt correction driving portion may be provided in a position in which a large amount of rotation occurs, and may effectively sense and correct tilting.

In another example embodiment, the tilt sensor 515 may be disposed on the inside of the tilt correction coil 513, and may oppose the tilt correction magnet 511.

Embodiments of the present disclosure aim to improve a focus adjustment function of a camera module.

According to example embodiments of the present disclosure, tilting of a lens, or the like, may be prevented, thereby improving focus adjustment performance of a camera module.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a housing having an internal space;
a lens barrel accommodated in the internal space and in which at least one lens is disposed along an optical axis direction;
a carrier accommodating the lens barrel and configured to be movable in the optical axis direction relative to the housing;
a rolling member disposed between the carrier and the housing, the rolling member being configured to roll along the optical axis direction;
a focus adjustment driving portion comprising a focus adjustment magnet and a focus adjustment coil opposite each other with the rolling member interposed therebetween, the focus adjustment driving portion being configured to generate focus driving force in the optical axis direction; and
a tilt correction driving portion, comprising a tilt correction magnet and a tilt correction coil, configured to generate a tilt driving force to offset tilting occurring in the carrier,
wherein the tilt correction driving portion generates the tilt driving force in the optical axis direction, and a direction of the tilt driving force is opposite to a direction of the focus driving force.

2. The camera module of claim 1, wherein the focus adjustment driving portion further comprises a first position sensor disposed on the housing to oppose the focus adjustment magnet,
wherein the focus adjustment magnet is disposed on one side surface of the carrier, and the focus adjustment coil is disposed on the housing to oppose the focus adjustment magnet with the rolling member interposed therebetween, and
wherein the camera module further comprises a first yoke disposed to oppose the focus adjustment magnet with the focus adjustment coil interposed therebetween, and configured to generate attractive force with the focus adjustment magnet.

3. The camera module of claim 2, wherein the tilt correction driving portion further comprises a tilt sensor disposed on the housing and configured to detect tilting of the carrier,
wherein the tilt correction magnet is disposed on another side surface of the carrier, and the tilt correction coil is disposed on the housing to oppose the tilt correction magnet.

4. The camera module of claim 3, wherein one side surface of the carrier on which the focus adjustment magnet is disposed and another side surface of the carrier on which the tilt correction magnet is disposed are either perpendicular or parallel to each other.

5. The camera module of claim 4, wherein
the tilt sensor is disposed to oppose the other side surface of the carrier on which the tilt correction magnet is disposed, and
a shortest distance from the one side surface of the carrier on which the focus adjustment magnet is disposed to the tilt sensor is greater than a shortest distance from the one side surface of the carrier on which the focus adjustment magnet is disposed to an optical axis.

6. The camera module of claim 4, wherein the tilt sensor is disposed on the housing to either oppose the tilt correction magnet or the focus adjustment magnet.

7. The camera module of claim 4, comprising:
a first frame coupled to the lens barrel and supported on the carrier with a plurality of ball members interposed therebetween,
wherein the first frame is movable in a first axis direction and a second axis direction, perpendicular to an optical axis, relative to the carrier, and
wherein the camera module further comprises an image stabilization driving portion comprising an image stabilization magnet and an image stabilization coil opposite each other and configured to generate driving force for moving the first frame in the first axis direction and the second axis direction.

8. The camera module of claim 7,
wherein the image stabilization magnet comprises a first image stabilization magnet disposed on one side surface of the first frame, and a second image stabilization magnet disposed on another side surface of the first frame, and
wherein the image stabilization coil comprises a first image stabilization coil disposed on the housing to oppose the first image stabilization magnet, and a second image stabilization coil disposed on the housing to oppose the second image stabilization magnet.

9. The camera module of claim 8, wherein
the one side surface of the carrier on which the focus adjustment magnet is disposed and the other side surface of the carrier on which the tilt correction magnet is disposed are perpendicular to each other, and
each of the first image stabilization magnet and the second image stabilization magnet is disposed to be parallel to one of the focus adjustment magnet and the tilt correction magnet.

10. The camera module of claim 8, wherein
the one side surface of the carrier on which the focus adjustment magnet is disposed and the other side surface of the carrier on which the tilt correction magnet is disposed are parallel to each other, and
the first image stabilization magnet and the second image stabilization magnet are disposed to be parallel to each other.

11. The camera module of claim 8, wherein the focus adjustment coil, the tilt correction coil, the first image stabilization coil, and the second image stabilization coil are disposed on different side surfaces of the housing, respectively.

12. The camera module of claim 11, further comprising:
a main board on which the focus adjustment coil, the tilt correction coil, the first image stabilization coil, and the second image stabilization coil are disposed,
wherein the main board is disposed across the entire side surfaces of the housing.

13. A camera module comprising:
a housing;
a carrier accommodating a lens barrel in which at least one lens is disposed along an optical axis direction and supported by the housing;
a focus adjustment driving portion comprising a focus adjustment magnet and a focus adjustment coil disposed on one side of the carrier;
a tilt correction driving portion comprising a tilt correction magnet and a tilt correction coil disposed on another side of the carrier;
a first rolling member, disposed on the one side of the carrier, comprising a first set of ball members; and
a second rolling member, disposed on the one side of the carrier to be spaced apart from the first rolling member, comprising a second set of ball members fewer than the first set of ball members,
wherein a shortest distance between the tilt correction driving portion and the first rolling member is equal to or greater than a shortest distance between the tilt correction driving portion and the second rolling member.

14. The camera module of claim 13, wherein the one side of the carrier on which the focus adjustment driving portion is disposed and the other side of the carrier on which the tilt correction driving portion is disposed are either perpendicular or parallel to each other.

15. The camera module of claim 13, wherein
a first position sensor configured to detect positions in the optical axis direction of the lens barrel and the carrier is disposed on the one side of the carrier; and
a tilt sensor configured to detect tilting of the lens barrel and the carrier is disposed either on the one side of the carrier or the other side of the carrier.
